(19) United States
(12) Patent Application Publication
(10) Pub. No.: US 2015/0125130 A1
(43) Pub. Date: May 7, 2015

(54) METHOD FOR NETWORK VIDEO RECORDER TO ACCELERATE HISTORY PLAYBACK AND EVENT LOCKING

(71) Applicant: Alpha Networks Inc., Hsinchu (TW)

(72) Inventors: Chung-Wang LEE, Hsinchu (TW); Yi LIU, Hsinchu (TW); Jin-Fuu LIN, Hsinchu (TW)

(73) Assignee: Alpha Networks Inc., Hsinchu (TW)

(21) Appl. No.: 14/313,442

(22) Filed: Jun. 24, 2014

(30) Foreign Application Priority Data
Nov. 1, 2013 (TW) 102139735

(51) Int. Cl. H04N 21/2743; H04N 9/87; H04N 21/438; G11B 27/10

(52) U.S. Cl. CPC H04N 21/2743; G11B 27/10; H04N 9/87; H04N 21/4382
USPC 386/241

(57) ABSTRACT

The present invention is to provide a method applicable to a player of a network video recorder for accelerating history playback and event locking, wherein the player decompresses a compressed file of recorded images when performing history playback of the recorded images, flags the resulting frames with “changed” or “unchanged”, depending on whether variation in image data traffic between the successive frames reaches a certain degree, and then sequentially plays the images of the successive frames on a monitor at different playing speeds which are set in the player and correspond to the successive “changed” and “unchanged” frames respectively. Thus, not only is the time required for history playback significantly shortened, but also a monitoring person is enabled to rapidly see, from among large amount of played back image data, the small number of images that demand attention and to greatly reduce the time, energy and effort required while monitoring.

### FIELD OF THE INVENTION

The present invention relates to a playback method, more particularly to a method applicable to a player of a network video recorder for accelerating history playback and event locking, so as to enable a monitoring person to rapidly see, from among large amount of played back image data, the small number of images that demand attention and to greatly reduce the time, energy and effort required while monitoring.

### BACKGROUND OF THE INVENTION

Generally, image surveillance systems are installed at specific locations whose images are required to be recorded for reference or as evidence. More specifically, an image surveillance system is configured to capture and record the images of a specific location so that unusual events taking place at the location can be monitored, allowing necessary measures to be taken accordingly. During installation, therefore, the cameras of the image surveillance system must be properly positioned at the intended location to ensure that the image-capturing range of the cameras covers the entire area to be monitored. Only then can a monitoring person or an image recognition system obtain the full picture of an unusual event from the images taken by the cameras. The phrase “properly positioned” also refers to a position where the angle of a camera is conveniently adjustable and where maintenance of the camera can be carried out with ease. About twenty years ago, the conventional image surveillance systems were typically based on an analog image surveillance platform, through which the NTSC (the US National Television System Committee) image signals of a camera are transmitted to a matrix-type surveillance host via a 5C2V coaxial cable and are, after selective switching, either output to a surveillance wall for real-time monitoring or stored in a recording device. Such an analog image surveillance platform not only is bulky and expensive, but also requires additional wiring; moreover, it does not allow real-time images to be simultaneously and arbitrarily viewed by many people. As a result, analog image surveillance platforms have gradually fallen out of favor in the market.

Recently, digital image surveillance equipment and network software have been greatly improved and become more and more affordable. Because of that, and due to the growing emphasis placed (by institutions, corporations, communities, and individuals, for example) on environmental preservation as well as on public and personal safety, the applications of and the demand for digital image surveillance systems have increased to such extent that these systems are replacing their analog counterparts and become the mainstream in the image surveillance market. A digital image surveillance platform serves mainly to capture digital images with an IP (Internet protocol) camera or is used to compress and digitize the analog images captured by a traditional camera. In either case, digital audio-video (AV) signals are transmitted through an IP network platform so that the images captured can be monitored and recorded at any point in the IP network. In order to minimize the bandwidth used by a digital image surveillance platform, a digital image surveillance system employing the platform must be able to properly compress the AV data flow captured and transmitted by its cameras. Today, the most common digital AV compression formats include H.264, MPEG-4, and M-JPEG, to name only a few. At the same time, however, it is almost an unstoppable market trend to use cameras with a relatively large number of image pixels, for these cameras can produce relatively clear images and thereby enable a monitoring person or an image recognition system to identify the persons or objects in the images with high efficiency. In the detection of criminals, for example, cameras with a relatively large number of pixels make it possible to identify human faces or car license plates accurately. Nevertheless, the prevalence of cameras with a large number of pixels also ensures that the resulting AV data flow will be so vast as to overwhelm IP networks. The huge AV data flow will occupy most of the available network bandwidth and most of the storage space in the recording equipment in use, adding to the difficulty and complexity of, and the time required for, computation by the image recognition system. Apart from that, the image quality of a camera tends to be affected by the image-taking angle and variations in ambient light. Should camera-captured images have low image resolution, they cannot be automatically analyzed by an image recognition system which is designed to compare the images against a back-end database. Consequently, the “target” cannot be accurately spotted in a series of successive images in real time, and it is imperative that the images be monitored, compared, and identified one after another by a person, which is both labor-intensive and very time-consuming Hence, high-end digital image surveillance platforms are generally required to use cameras with high resolution in order to deal with different image-taking angles and variations in ambient light. Still, as stated above, cameras with high resolution will generate a large AV data flow, which occupies network bandwidth and storage space and hinders image transmission and automatic recognition. To compensate for these drawbacks, the addition of faster and more expensive network equipment and central processing units is called for, which however leads to the high prices of high-end digital image surveillance platforms and prevents such platforms from being widely used.

As previously mentioned, the most frequently used image compression and decompression techniques nowadays include H.264, MPEG-4, and M-JPEG. The different formats correspond to different image resolutions, different numbers of frames per second, different transmission speeds, and different storage sizes. For one who rents a dedicated line bandwidth from a telecommunication company in order to transmit digital surveillance images, the compression and decompression technique to be used by the intended digital image surveillance platform is typically chosen based on the following principles:

1. H.264 has the optimal compression rate, requires a small bandwidth and storage size, and is therefore suitable for self-built wire-based networks. However, images may blur when transmitted over an unstable bandwidth network.

2. M-JPEG is suitable for self-built wireless networks because, although it requires a relatively large bandwidth, stable recording quality is ensured even in unstable bandwidth conditions.

Currently, image recording techniques are mainly digital, and the image recording structure employed plays an important role in system maintenance and transmission bandwidth. Based on existing techniques, image storing and viewing structures can be generally divided into the following two categories:

1. Front-end-distributed storage structure: also known as the “digital video recorder (DVR)” distributed management structure, as indicated by the reference numeral 1 in FIG. 1. As shown in the drawing, cameras 10 and digital recorders 11, among other devices, are provided at the front-end surveillance sites. Images captured by the cameras 10 are directly compressed by and immediately stored into the corresponding digital recorders 11. Generally speaking, 4˜16 cameras 10 share one digital recorder 11. Therefore, this structure is suitable for use where the surveillance sites are few and far between and where the entire area to be monitored is relatively large. Further, with this structure, history images are more often copied in situ for use than viewed via a network. Nonetheless, the front-end-distributed storage structure disadvantageously requires cumbersome on-site equipment; occupies considerable space, which is at a premium; is difficult to install and unsightly once installed; is not suitable for use in a highly humid and hot outdoor environment; cannot be easily serviced; does not provide easy image viewing; and is limited in terms of value-added functions of the back-end surveillance platforms 12. Because of the above, the front-end-distributed storage structure is applicable only in specific indoor settings such as the atrium of a building (to monitor the atrium) or a parking lot (to monitor the environment of the parking lot).

2. Back-end-centralized storage structure: also known as the “network video recorder (NVR)” distributed management structure, as indicated by the reference numeral 2 in FIG. 2. Referring to FIG. 2, images captured on site by the IP cameras 20 are immediately compressed either directly or via the corresponding digital video servers (DVSs) 21, before transmission to a remote machine room 22 for storage. Each workstation 23 can view the images arbitrarily, either directly or via a network. As only the IP cameras 20 are installed at the front-end surveillance sites, on-site equipment has smaller physical volume, is easier to install, and is less unsightly than that of the front-end-distributed storage structure. The recording main machines 221 are provided in the remote machine room 22 in a centralized manner Each workstation 23 can connect to the remote machine room 22 either directly or through a network, in order to capture and view images. Therefore, not only can several people view the recorded images simultaneously in the remote machine room 22, but also the recording main machines 221 feature easy management, facile maintenance, and high security. If the recording main machines 221 are high-performance servers, recording functions and capacities can be readily expanded, in addition to providing intelligent image recognition and comparison and value-added applications. For instance, the recording time of specific IP cameras 20 can be extended, and the image transmission bandwidths and the number of frames displayed per second can be adjusted to meet practical needs. The back-end-centralized storage structure is suitable for surveillance within communities and for monitoring traffic, crossroads, harbors, and other large areas.

The present invention is directed to improving the NVR distributed management structure. The current operational aspects of the NVR distributed management structure are briefly stated as follows, in which the image platform of a digital recording surveillance system commonly used by large institutions is provided by way of example. Referring to FIG. 3, the digital recording surveillance system 3 includes a plurality of IP cameras 30 respectively disposed at security-critical locations inside and outside an institution. Recording and broadcasting servers 321 are installed in security rooms or a central control room 32. Images captured by the IP cameras 30 are digitally compressed into the H.264 (720×480, 15FPS) or H.264 (1280×960, 7FPS) format and immediately transmitted via a rented virtual private network (VPN) image transmission network 33 to the recording and broadcasting servers 321 in the security rooms or central control room 32. Each security guard can log on to a recording and broadcasting server 321 using the system default authority, or any other person can log on to a recording and broadcasting server 321 through a workstation 34 of the unit to which the person belongs, before viewing the recorded images and performing various functions. In addition to such system functions as graphic control, mechanism position information, equipment surveillance, and maintenance management, some systems are further provided with an intelligent image recognition function. The system function of graphic control provides comprehensive resource services, mainly including platform authority management, resource allocation, event management, and electronic map functions. The graphic control function has a distributed multilayer structure that allows the user to monitor real-time images and play back recorded images through a graphic control interface.

It can be known from the above that, using the algorithm software of the recording and broadcasting servers, the digital recording surveillance system can analyze the images captured by the IP cameras, with a view to automatically monitoring the event state of the area under surveillance. Any identified event is transmitted to the central computer system in the central control room, accompanied by an alert, so that the central computer system is enabled to perform emergency management and personnel dispatch. The intelligent image recognition function of the system serves mainly to perform intelligent analyses on the image signals obtained, wherein the analyses include digitizing, capturing, comparing, tracking, analyzing, and recording the image input source with a built-in image capture card. The event detection function of the system not only can automatically detect and identify events, but also can mark moving or unusual objects in a series of successive images from the start to the end of any of the following events:

(1) Referring to FIG. 4, moving objects (e.g., cars or persons) outside an institution are monitored and respectively marked with highlighted brackets 40 of a specific color (e.g., red), which enable a monitoring person to monitor the moving objects via eye contact.

(2) Referring to FIG. 5, an unusual object (e.g., a suspicious parcel) emerging at a security-critical location in an institution is monitored and marked with a highlighted bracket 41 of a specific color (e.g., yellow), which enables a monitoring person to pay attention to the newly emerging unusual object and its emerging process via eye contact.

(3) Referring to FIG. 6, an object (e.g., a suitcase) displaced or stolen from a security-critical location in an institution is monitored and marked with a highlighted bracket 42 of a specific color (e.g., blue), which enables a monitoring person to pay attention, via eye contact, to the displaced or stolen object and the process of its being displaced or stolen.

(4) Referring to FIG. 7, it is monitored whether the camera at a security-critical location in an institution is out of focus. Should the camera become out of focus, a specific highlighted symbol 43 (e.g., an exclamation mark) is shown to alert a monitoring person to the focus problem while the person monitors the images via eye contact.

(5) Referring to FIG. 8, it is monitored whether the field of view of the camera at a security-critical location in an institution is blocked. Should the field of view of the camera be blocked, a specific highlighted symbol 44 (e.g., a hand) is shown to alert a monitoring person to the blocked field of view while the person monitors the images via eye contact.

Generally speaking, the images recorded by the foregoing digital recording surveillance system is a series of frames, whose data are successively stored into at least one recorded image file according to the temporal sequence of the frames, as are the frames of a movie or a television program. To spot an unusual event in real time, it is necessary for a monitoring person to monitor the images, or frames, by eye contact. The intelligent recognition function of the foregoing digital recording surveillance system only marks out the changing object or objects in the images in order for the monitoring person to pay attention to, analyze, and determine the object or objects, thereby spotting an unusual event. More specifically, the monitoring person compares the images (which emerge successively along the time axis) in a frame-by-frame manner in order to find any changes in the overall image data. Thus, the target (i.e., the changed object or objects) in the images is determined and is marked accordingly. The intelligent recognition process described above demands extremely high computer performance. In addition, when recording the images captured by the cameras, the foregoing digital recording surveillance system uses the aforementioned image compression software to compress the successive images and thereby economize on storage space. During compression, only the changed portion of the successive frames is recorded. When it is desired to perform history playback of the recorded images after a certain event occurs, the recorded images must be decompressed using image decompression software before history playback can be performed. Then, a monitoring person still has to look for, monitor, and identify the small number of images related to the event from among the vast number of frames. The time, energy, and viewing effort required of the monitoring person are considerable.

To sum up, an NVR digital image surveillance system is configured mainly for full-time image recording at specific locations for surveillance purposes. In addition to taking into account such factors as user needs and compatibility with peripheral equipment, it is highly desirable that image playback quality can be effectively enhanced, history playback made more efficient, and event identification ability improved, without incurring extra costs for purchasing high-image quality image equipment, high-capacity recording equipment, or high-speed network equipment. The goal, shared by image surveillance product manufactures and network service providers alike, is to promote the use of high-end NVR digital image surveillance systems in various fields.

### BRIEF SUMMARY OF THE INVENTION

It is an objective of the present invention to provide a method for a network video recorder to accelerate history playback and event locking, wherein the method is applicable to a player of the network video recorder. The player decompresses a compressed file of recorded images when performing history playback of the recorded images. The player then flags the resulting frames with “changed” or “unchanged”, depending on whether variation in image data traffic between the successive frames reaches a certain degree. When the player sequentially plays the images of the successive frames on a monitor, the images of the successive frames are played at different playing speeds, which are set in the player and which correspond to the successive “changed” frames and the successive “unchanged” frames respectively. Thus, not only is the time required for history playback significantly shortened, but also a monitoring person is enabled to rapidly see, from among the large amount of played back image data, the small number of images that demand attention. Consequently, the time, energy, and viewing effort required of the monitoring person are greatly reduced. Furthermore, the monitoring person is allowed plenty of time to look closely at the “changed” portion of the successive frames and can therefore attentively monitor the whole process of an event and rapidly and correctly analyze and determine the real cause of the event. The method of the present invention enables an inexpensive recording surveillance system to achieve fast history playback and event locking typical of high-end recording surveillance systems, and all that is needed is a small amount of computer calculation rapidly executed under simple software computation conditions.

Another objective of the present invention is to provide the foregoing method, wherein the method can further set different levels (e.g., “significantly changed”, “moderately changed”, “slightly changed”, and “unchanged”) according to how image data traffic is changed between successive frames, mark each frame with the corresponding level, sequentially play the images of the successive frames on a monitor at different playing speeds which are set in the player and which correspond respectively to the different levels, and mark the screen images of the monitor with the corresponding levels respectively. This allows a monitoring person monitoring history playback to pay more attention to the significantly changed portion of the successive frames, thereby rapidly and correctly determining the real cause of the event.

Yet another objective of the present invention is to provide the foregoing method, wherein the playing speed of the successive unchanged frames is higher than a normal playing speed, and wherein the playing speeds of the successive changed frames are lower than the normal playing speed and decrease as the change levels increase.

### BRIEF DESCRIPTION OF THE SEVERAL VIEWS OF THE DRAWINGS

The objectives, as well as the technical features and their effects, of the present invention will be best understood by referring to the following detailed description of some illustrative embodiments in conjunction with the accompanying drawings, in which:

FIG. 1 is a schematic diagram of the conventional front-end-distributed storage structure;

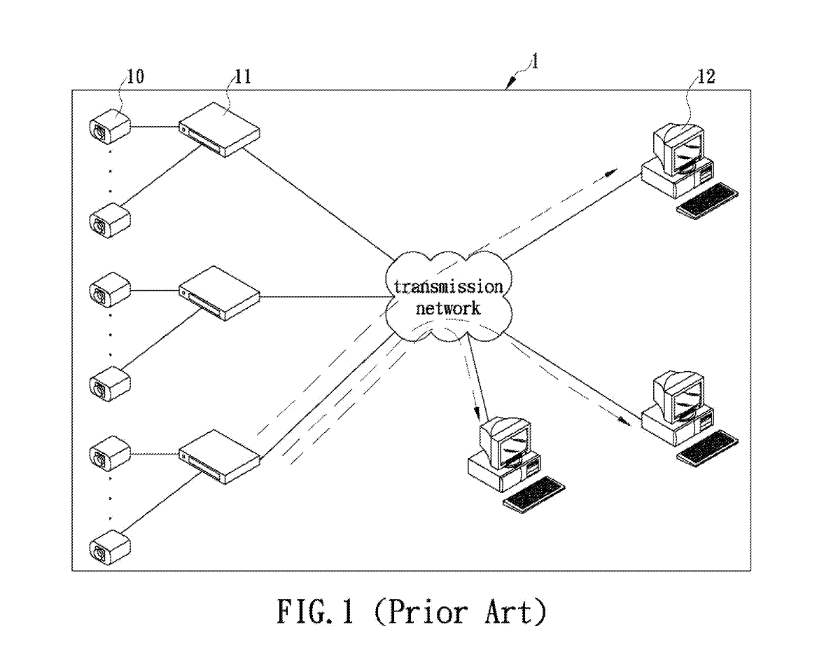

FIG. 2 is a schematic diagram of the conventional back-end-centralized storage structure;

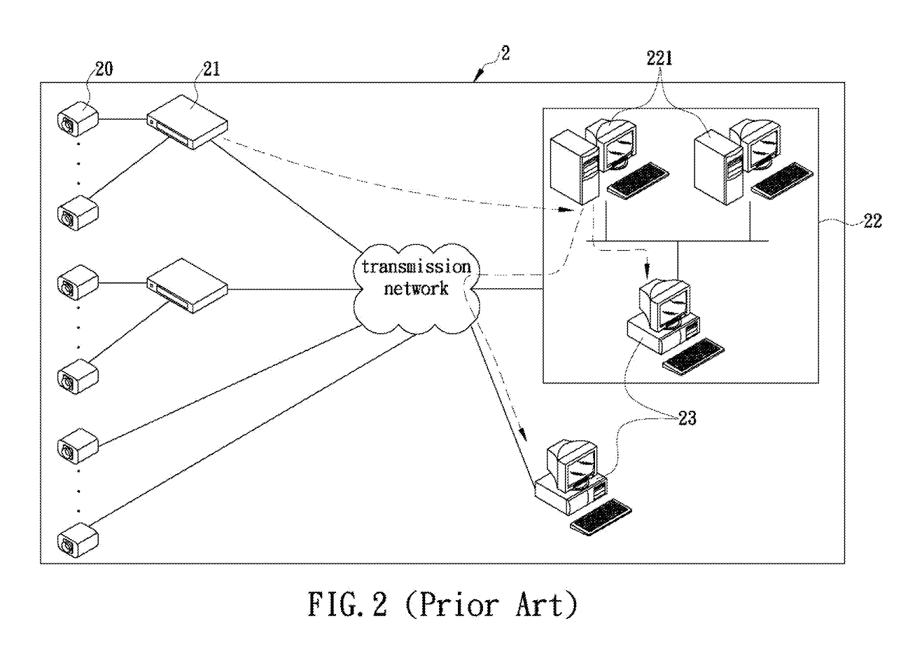

FIG. 3 schematically shows the operational aspects of the conventional NVR distributed management structure;

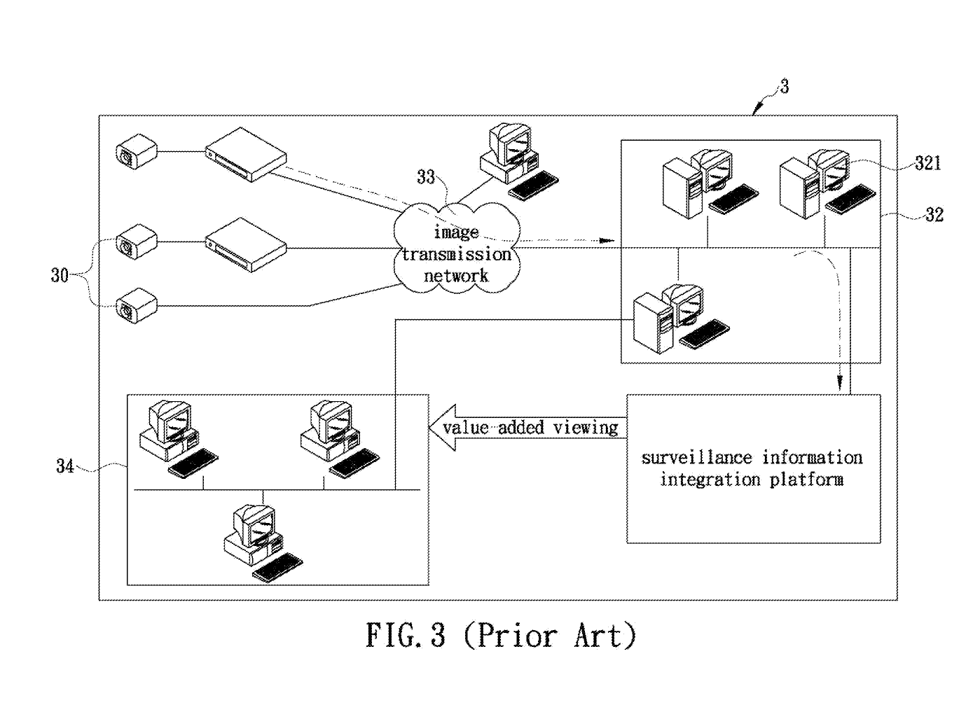

FIG. 4 schematically shows how the images of moving objects outside an institution are conventionally monitored;

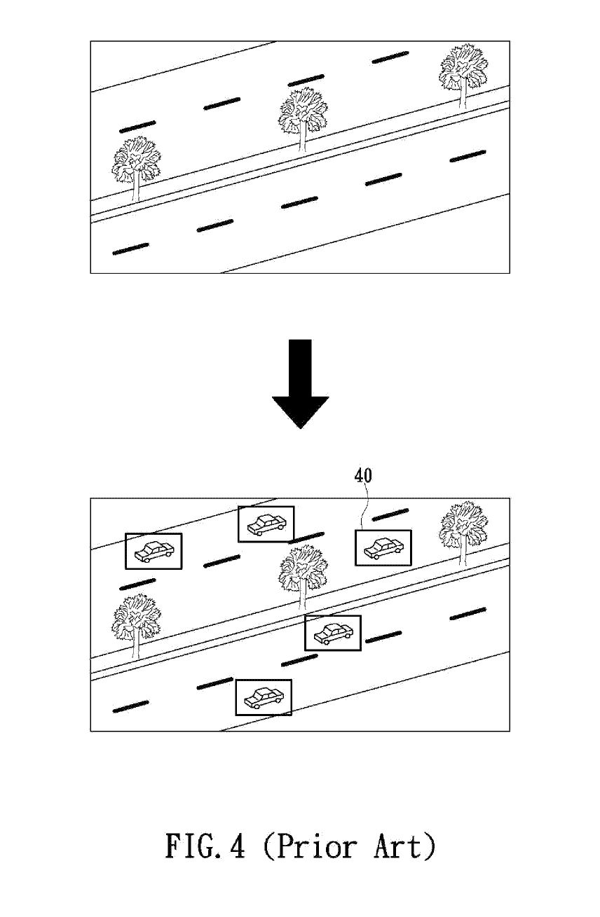

FIG. 5 schematically shows how the image of an unusual object emerging at a security-critical location inside an institution is conventionally monitored;

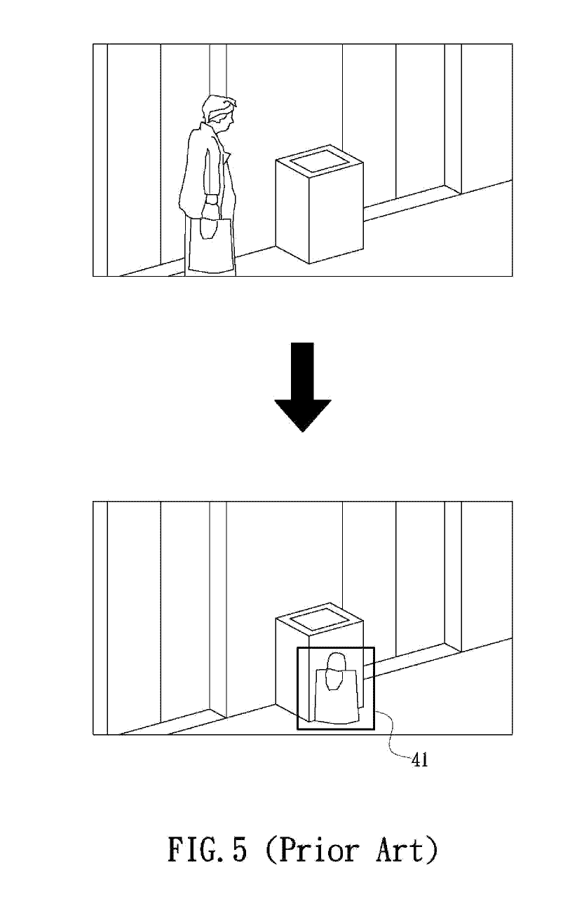

FIG. 6 schematically shows how the image of an object displaced or stolen from a security-critical location inside an institution is conventionally monitored;

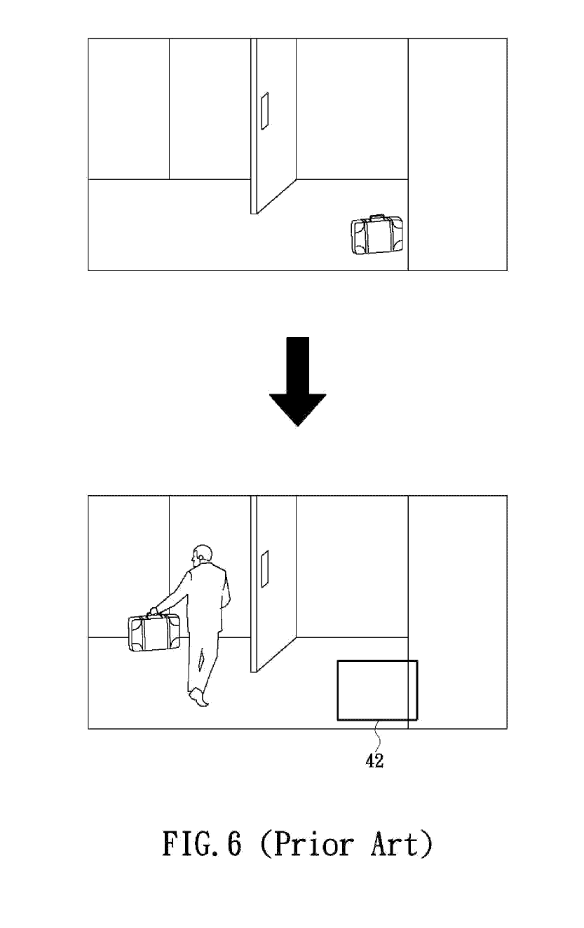

FIG. 7 schematically shows how an out-of-focus image captured by the camera at a security-critical location inside an institution is conventionally monitored;

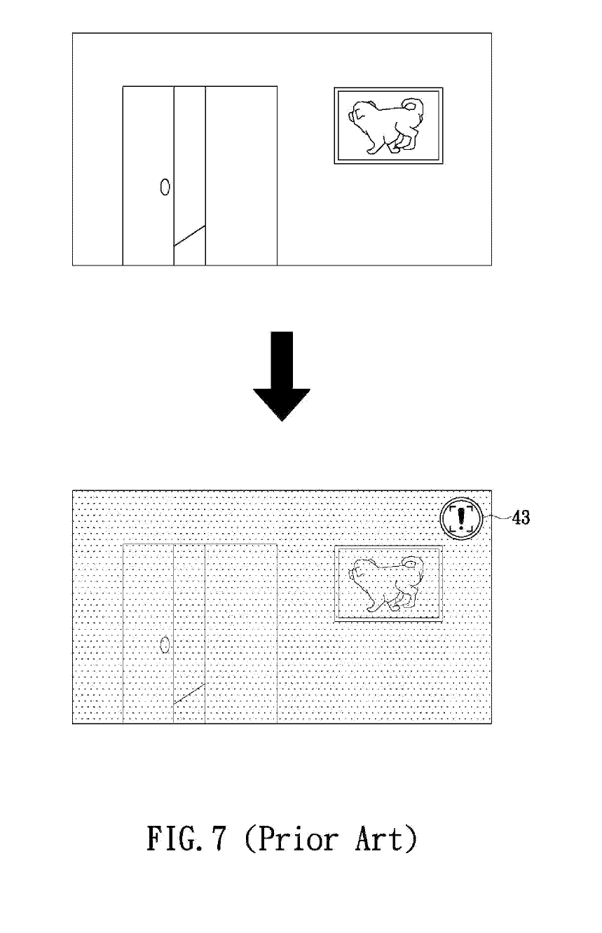

FIG. 8 schematically shows how the image of a camera which is provided at a security-critical location inside an institution and whose field of view is blocked is conventionally monitored;

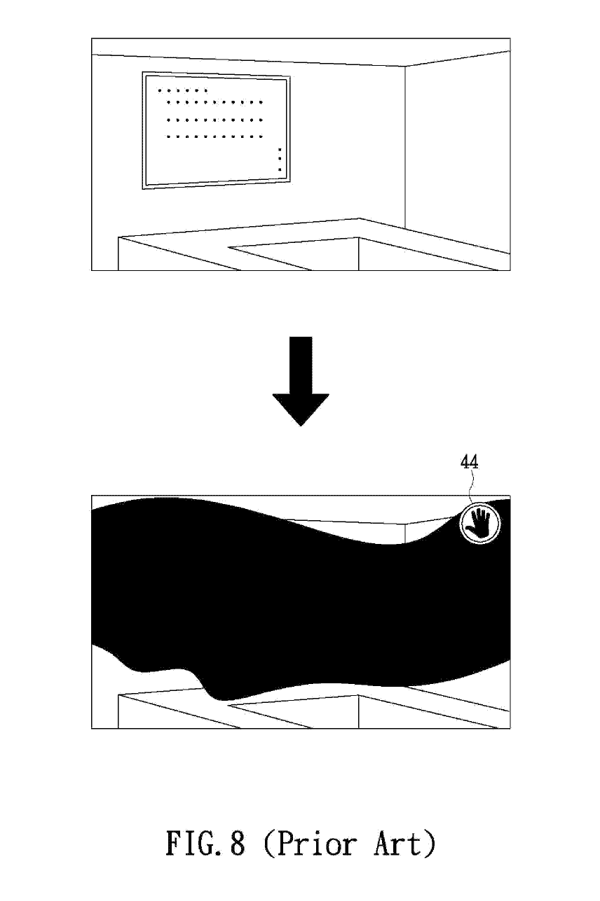

FIG. 9 is the flowchart of the method according to a preferred embodiment of the present invention; and

FIG. 10 is the flowchart of the method according to another preferred embodiment of the present invention.

### DETAILED DESCRIPTION OF THE INVENTION

After long-term research on images recorded by existing digital recording surveillance systems, the inventor of the present invention has found that the player(s) of a digital recording surveillance system cannot perform history playback of the recorded images of an event until the compressed recorded image file is decompressed with image decompression software to restore the recorded image file to the original successive frame data. Once the compressed file is decompressed, the image of each frame is sequentially displayed on a monitor for viewing and identification by a monitoring person. Take for example the MPEG-4 format, which requires that 30 images be sequentially played per second. If MPEG-4 images lasting 24 hours (i.e., 86400 seconds) are to be monitored, a total of nearly 2.6 million successive images need to be viewed. Not only is the process exceedingly time-consuming, but also the monitoring person will have to look for, monitor, and identify the small number of related images from among the huge number of frames, which is a heavy burden on the monitoring person's stamina and eyesight.

It has been found that, during the compression process, the aforementioned image compression software records only the changed portion of a series of successive frames which emerge one after another along the axis of time. In fact, the corresponding objects in each two adjacent frames are moved or changed only slightly in most of the time. This explains why the image compression software need not record the entire image of each frame. Instead, only a few key frames are selected from the whole series of successive frames and stored. As to the rest of the frames that exist between the key frames, only information related to image change with respect to the key frames is stored. This image change (in the non-key frames) with respect to the key frames is smaller in size than the entire image of each non-key frame and therefore only needs a small storage space for storage.

In light of the above, the inventor of the present invention has found that, when performing history playback of the images recorded by an existing digital recording surveillance system, the following three criteria determine whether an image is directly and closely related to an event:

(1) Whether data traffic between successive frames is changed?

(2) Whether variation in data traffic between successive frames reaches a certain degree? Or whether the area of change reaches a certain extent?

(3) The starting and ending times of variation in data traffic between successive frames.

Hence, if the player(s) of a digital recording surveillance system can detect variation in data traffic between successive frames per unit time when decompressing the recorded images, “changed” frames can be distinguished from “unchanged” frames. Herein, the term “changed” refers to a case in which variation in data traffic between successive frames per unit time has reached a certain degree, or in which the changed area has reached a certain extent. In other words, a “changed” frame must contain a moving object larger than a certain size or have the scene in the frame completely changed. When performing history playback, therefore, a player may be so configured as to play the “changed” portion of the successive frames in slow motion (i.e., slower than a normal playing speed) and the “unchanged” portion of the successive frames in fast motion (i.e., faster than the normal playing speed), thus not only substantially shortening the time required for history playback, but also allowing the monitoring person more time to watch the “changed” portion of the successive frames. By doing so, the monitoring person can look closely at the whole process of an event and determine the real cause of the event correctly and rapidly.

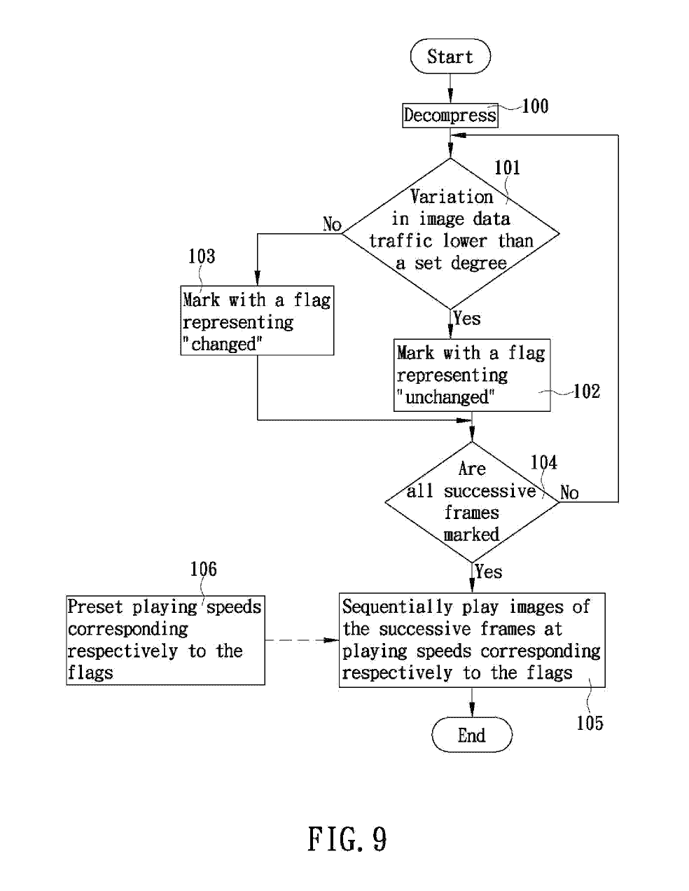

Based on the ideas disclosed above, the inventor has developed a method whereby a network video recorder can accelerate history playback and event locking. The method is perfect for use where surveillance is needed, particularly where the video images of a monitored area are static or only slightly changed in most of the time, and where all that a monitoring person has to look for is variation in image data traffic between successive frames that occurs within a short time. Under such circumstances, it is of practical meaning to be able to efficiently find or retrieve the “changed” portion of the successive frames when history playback is performed, for by doing so, the monitoring person only has to monitor a small number of images that deserve attention, rather than a huge number of recorded images. This will greatly reduce the time, energy, and viewing effort required of the monitoring person. Moreover, the monitoring person will have sufficient time to correctly analyze the “changed” portion of the successive frames. Thus, with a small amount of computer calculation rapidly executed under simple software computation conditions, an inexpensive recording surveillance system can efficiently perform history playback and event locking, which is achievable only by high-end recording surveillance systems. Referring to FIG. 9 for a preferred embodiment of the present invention, the method is applied to a player of a network video recorder (NVR). The player includes decompression software and performs the following steps on a compressed file of recorded images when carrying out history playback of the recorded images:

(100) The player begins by decompressing the compressed file of the recorded images with the decompression software. As a result, a plurality of successive frames are obtained.

(101) The player determines whether variation in image data traffic between two adjacent successive frames is lower than a set degree (e.g., 1%). Step (102) is performed if yes, and step (103) is performed if not.

(102) Upon determining that the variation in image data traffic between the latter frame and the former frame does not reach the set degree (i.e., being lower than the set degree), the latter frame is marked with a flag representing “unchanged”, and step (104) is performed.

(103) Upon determining that the variation in image data traffic between the latter frame and the former frame reaches the set degree (i.e., being not lower than the set degree), the latter frame is marked with a flag representing “changed”, and step (104) is performed.

(104) The player determines whether all the successive frames in the compressed file have been marked. If yes, step (105) is performed; if not, step (101) is performed to mark the following frames.

(105) According to the different playing speeds preset in the player that correspond respectively to the successive changed frames and the successive unchanged frames (i.e., the preset playing speeds corresponding respectively to the flags (106)), the player sequentially plays the images of the successive frames on a monitor, wherein the playing speed of the successive unchanged frames is higher than a normal playing speed, and the playing speed of the successive changed frames is lower than the normal playing speed.

As the unchanged frames are played at a higher speed, the otherwise long history playback time is significantly shortened, and the monitoring person is enabled to rapidly find, from among the vast number of recorded images, the small number of images that really demand attention. In consequence, the time, energy, and viewing effort required of the monitoring person are substantially reduced. On the other hand, with the successive changed frames being played at a lower speed, the monitoring person has enough time to monitor the “changed” portion of the successive frames and hence the entire process of an event, without having to perform history playback repeatedly.

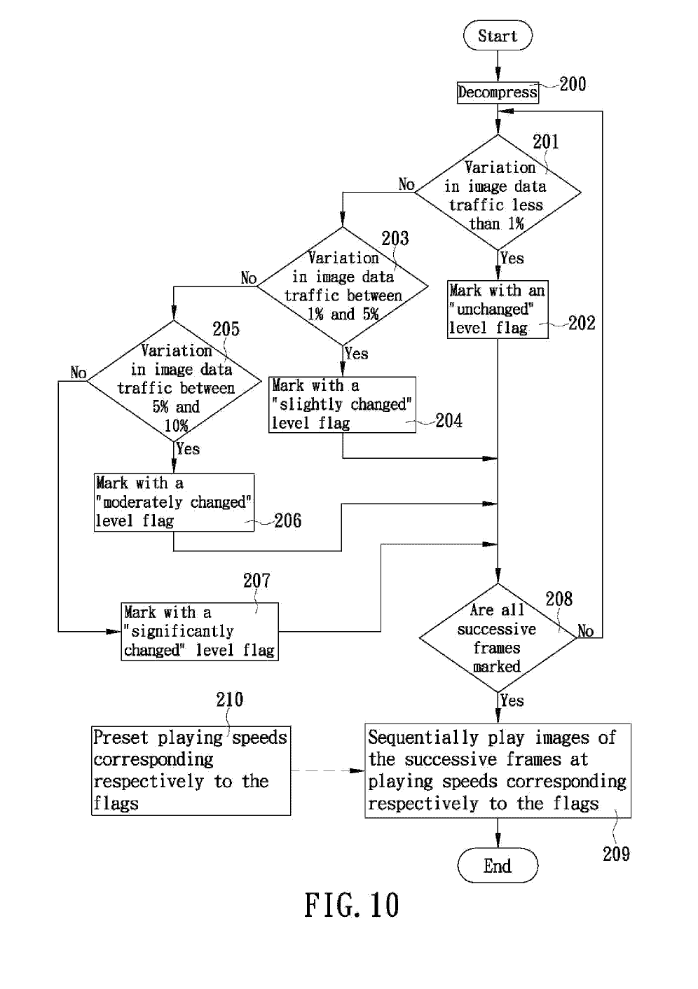

In another preferred embodiment of the present invention as shown in FIG. 10, the method is applied to a player of a network video recorder. The player includes decompression software and performs the following steps on a compressed file of recorded images when carrying out history playback of the recorded images:

(200) The player decompresses the compressed file of the recorded images with the compression software. As a result, a plurality of successive frames are obtained.

(201) The player determines whether the degree of variation in image data traffic (or the extent of the changed area) between two adjacent successive frames belongs to one of several set levels (e.g., the “unchanged” level corresponding to a degree of variation in data traffic less than 1% or a changed area less than 1% in extent, the “slightly changed” level corresponding to a degree of variation in data traffic between 1% and 5% or a changed area between 1% and 5% in extent, the “moderately changed” level corresponding to a degree of variation in data traffic between 5% and 10% or a changed area between 5% and 10% in extent, and the “significantly changed” level corresponding to a degree of variation in data traffic greater than 10% or a changed area greater than 10% in extent) and then marks the frames with the corresponding levels respectively. Step (202) is performed if it is determined that variation in image data traffic (or the extent of the changed area) between the latter image and the former image is less than 1%, and step (203) is performed if otherwise.

(202) The latter image is marked with a flag representing the “unchanged” level, and then step (208) is performed.

(203) If it is determined that variation in image data traffic (or the extent of the changed area) between the latter image and the former image is between 1% and 5%, step (204) is performed; otherwise, step (205) is performed.

(204) The latter image is marked with a flag representing the “slightly changed” level, and then step (208) is performed.

(205) If it is determined that variation in image data traffic (or the extent of the changed area) between the latter image and the former image is between 5% and 10%, step (206) is performed; otherwise, step (207) is performed.

(206) The latter image is marked with a flag representing the “moderately changed” level, and then step (208) is performed.

(207) The latter image is marked with a flag representing the “significantly changed” level, and then step (208) is performed.

(208) The player determines whether all the successive frames in the compressed file have been marked. If yes, perform step (209); if not, perform step (201) to mark the following frames.

(209) According to the different user-preset playing speeds in the player that correspond respectively to the various levels (210), the player sequentially plays the images of the successive frames on a monitor and marks each played image with the corresponding level, wherein the playing speed of the successive unchanged frames is higher than a normal playing speed, and the playing speeds of the successive changed frames are lower than the normal playing speed and decrease as the change levels increase. Thus, a monitoring person can pay more attention to the significantly changed portion of the successive frames during the monitoring process to correctly determine the real cause of the event.

To clearly determine variation in image data traffic between successive frames, the player in the foregoing embodiment when performing history playback of the recorded images will first use the decompression software to determine the unchanged portion of the successive frames that emerge one after another along the time axis. Then, one frame is selected from the successive unchanged frame sequence as a key frame. The player subsequently determines the degree of variation in image data traffic (or the extent of the changed area) between each frame in the following successive changed frame sequence and the key frame. The player then marks each recorded image with the corresponding flag or level. Thus, when performing history playback of the recorded images, the player can sequentially play the images of the successive frames on a monitor at the corresponding playing speeds preset in the player, wherein the preset playing speeds may be set by the user or the system designer. As stated above, the full-time images recorded by the digital recording surveillance system do not show significant variation in image data traffic between the images except in very short periods when some object or objects in the images are substantially moved. In most of the time, the objects in the successive frames are stationary or are barely moved. Therefore, with the method of the present invention, by which the player can rapidly play the images of the successive unchanged frames on a monitor, or play only the key frames while showing the starting time and ending time of the successive unchanged frames and skipping the rest of the successive unchanged frames, one who monitors a history playback of network video recording can skip the lengthy successive unchanged frames and focus on those successive frames in which a significant change takes place within a short period of time. By so doing, the monitoring person can readily find and lock on to the unusual event in the “changed” portion of the successive frames and can rapidly conduct correct analysis and judgment to know the whole process and real cause of the unusual event. In a nutshell, the method of the present invention serves as an interface between an existing player and existing decompression software so that, with minimum computer calculation rapidly carried out under simple software computation conditions, an inexpensive recording surveillance system can efficiently perform the history playback and event locking functions of a high-end recording surveillance system. The method of the present invention, therefore, should be considered as satisfying the novelty and non-obviousness requirements for patent application.

While the invention herein disclosed has been described by means of specific embodiments, numerous modifications and variations could be made thereto by those skilled in the art without departing from the scope of the invention set forth in the claims.

What is claimed is:

1. A method for a network video recorder (NVR) to accelerate history playback and event locking, the method being applicable to a player of the network video recorder, wherein the player includes decompression software, the method comprising the steps, to be performed by the player on a compressed file of recorded images when the player performs history playback of the recorded images, of:
(1-1) decompressing the compressed file of the recorded images to obtain a plurality of successive frames;
(1-2) determining whether variation in image data traffic between two adjacent successive said frames reaches a set degree, and performing step (1-3) if yes and step (1-4) if not;
(1-3) marking the latter of the two adjacent successive frames with a flag representing “changed” upon determining that the variation in image data traffic between the two adjacent successive frames reaches the set degree, and performing step (1-5);
(1-4) marking the latter of the two adjacent successive frames with a flag representing “unchanged” upon determining that the variation in image data traffic between the two adjacent successive frames does not reach the set degree, and then performing step (1-5);
(1-5) determining whether all the successive frames in the compressed file are marked, and performing step (1-6) if yes and step (1-2) if not, so as to mark each following said frame; and
(1-6) sequentially playing images of the successive frames on a monitor at playing speeds preset in the player, wherein the playing speeds are preset by a user and correspond respectively to the flags.

2. The method of claim 1, wherein the playing speed corresponding to the flag representing “changed” is lower than the playing speed corresponding to the flag representing “unchanged”.

3. The method of claim 1, further comprising the steps, to be performed by the player when performing history playback of the recorded images, of: determining through the decompression software an unchanged portion of the successive frames that emerge one after another along an axis of time; selecting one said frame from a successive unchanged frame sequence as a key frame; determining a degree of variation in image data traffic, or an extent of a changed area, between each said frame in a subsequent successive changed frame sequence and the key frame; and marking each said frame with a corresponding said flag.

4. The method of claim 2, further comprising the steps, to be performed by the player when performing history playback of the recorded images, of: determining through the decompression software an unchanged portion of the successive frames that emerge one after another along an axis of time; selecting one said frame from a successive unchanged frame sequence as a key frame; determining a degree of variation in image data traffic, or an extent of a changed area, between each said frame in a subsequent successive changed frame sequence and the key frame; and marking each said frame with a corresponding said flag.

5. A method for a network video recorder (NVR) to accelerate history playback and event locking, the method being applicable to a player of the network video recorder, wherein the player includes decompression software, the method comprising the steps, to be performed by the player on a compressed file of recorded images when the player performs history playback of the recorded images, of:
(5-1) decompressing the compressed file of the recorded images to obtain a plurality of successive frames;
(5-2) determining a degree of variation in image data traffic, or an extent of a changed area, between two adjacent successive said frames;
(5-3) marking the latter of the two adjacent successive frames with a flag of a corresponding level;
(5-4) determining whether all the successive frames in the compressed file are marked, and performing step (4-5) if yes and step (4-2) if not, so as to perform level marking on each following said frame; and
(5-5) sequentially playing images of the successive frames on a monitor at different playing speeds preset in the player, wherein the playing speeds are preset by a user and correspond respectively to various said levels.

6. The method of claim 5, wherein step (5-5) further comprises showing the level corresponding to each said frame on a corresponding said image on the monitor.

7. The method of claim 5, wherein the playing speeds corresponding to changed ones of the successive frames are lower than the playing speed corresponding to unchanged ones of the successive frames and decrease as the levels corresponding to the changed ones of the successive frames increase.

8. The method of claim 6, wherein the playing speeds corresponding to changed ones of the successive frames are lower than the playing speed corresponding to unchanged ones of the successive frames and decrease as the levels corresponding to the changed ones of the successive frames increase.

9. The method of claim 7, further comprising the steps, to be performed by the player when performing history playback of the recorded images, of: determining through the decompression software an unchanged portion of the successive frames that emerge one after another along an axis of time; selecting one said frame from a successive unchanged frame sequence as a key frame; determining a degree of variation in image data traffic, or an extent of a changed area, between each said frame in a subsequent successive changed frame sequence and the key frame; and marking each said frame with a said flag of a corresponding said level.

10. The method of claim 8, further comprising the steps, to be performed by the player when performing history playback of the recorded images, of: determining through the decompression software an unchanged portion of the successive frames that emerge one after another along an axis of time; selecting one said frame from a successive unchanged frame sequence as a key frame; determining a degree of variation in image data traffic, or an extent of a changed area, between each said frame in a subsequent successive changed frame sequence and the key frame; and marking each said frame with a said flag of a corresponding said level.

11. The method of claim 9, wherein the levels are divided into “unchanged”, “slightly changed”, “moderately changed”, and “significantly changed” according to the degrees of the variations in image data traffic or the extents of the changed areas.

12. The method of claim 10, wherein the levels are divided into “unchanged”, “slightly changed”, “moderately changed”, and “significantly changed” according to the degrees of the variations in image data traffic or the extents of the changed areas.
